(19) United States
(12) Patent Application Publication
(10) Pub. No.: US 2008/0070307 A1
(43) Pub. Date: Mar. 20, 2008

(54) Temperature History Indicator

(75) Inventor: Ryuichi Kodama, Kashiwa-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: POWDERTECH CO., LTD., Kashiwa-shi (JP)

(21) Appl. No.: 11/853,439

(22) Filed: Sep. 11, 2007

(30) Foreign Application Priority Data
Sep. 15, 2006 (JP) 2006-251829

(51) Int. Cl. G01N 21/78; G01N 21/75

(52) U.S. Cl. 436/2; 422/57; 422/58

(57) ABSTRACT

A temperature history indicator equipped with an oxygen detecting agent main body which changes in color in response to the oxygen concentration and a slightly gas-permeable packaging film for sealing and coating said oxygen detecting agent main body. The packaging film is a laminated film of two or more kinds of films including any of polymers selected from polyethylene terephthalate (PET), polyacrylonitrile (PAN), polyamide (NY) and polyethylene (PE). A temperature history indicator set equipped with the temperature history indicator and color sample showing the relationship between a temperature and a color tone change with time is also provided. A method of controlling a temperature history of goods by using the above-mentioned indicator is also disclosed.

### BACKGROUND OF THE INVENTION

1. Field of the Invention

The present invention relates to a temperature history indicator, more particularly to a temperature history indicator capable of controlling the quality of fresh foods and the like freshly, conveniently and securely at a predetermined temperature in the range of −10° C. to +10° C. which is a refrigeration range of foods, drugs and various machinery and appliances, and a temperature history indicator set using the temperature history indicator as well as a method of controlling a temperature history of goods using them.

2. Description of the Related Art

In recent years, in the fields of drugs and medical supplies, printing inks and electricity, machinery and appliances in addition to the field of foods, some goods are transported, preserved (stored) and processed in a frozen or refrigerated state or at a chilled temperature (that is, a temperature of more than 0° C. to approximately +5° C.) or further at a specific temperature of 0° C. or more from the view point of the quality maintenance of goods.

For the goods represented by the foods, there have been proposed various attachable temperature control labels, temperature history indicators and the like so that the temperature history is clear at a glance in the quality control, and some of them have been used in practice.

As a temperature history indicator of which target temperature is 0° C. or less, for example, there can be mentioned those described in Japanese Patent Laid-Open Publication No. 2005-114363, Japanese Patent Laid-Open Publication No. 2005-114364 and the like.

The above patent documents disclose “a low temperature history indicator comprising an emulsified liquid which has been frozen at below zero temperatures in a sealed vessel, wherein the emulsified liquid is phase separated by the increase in temperature, and is composed of water, a fatty acid and a sodium salt of a fatty acid, wherein the water contains an additive consisting of saccharides or macromolecular compounds”. However, the low temperature history indicators described in these patent documents contain an emulsified liquid in a liquid state at room temperature. Therefore, there are such problems that the liquid leakage may be likely to occur depending on the handling manner of the indicators; the leaked liquid adheres to foods and the like for which the low temperature history has to be controlled and is likely to contaminate them; and the low temperature history indicators are inferior in visibility for the temperature history in the range of −20° C. to 0° C.

Meanwhile, as indicators of which target temperature is 0° C. or more, there can be mentioned those described in Japanese Patent Laid-Open Publication No. 2002-129139, Japanese Patent Laid-Open Publication No. 2003-342428 and Japanese Patent Laid-Open Publication No. 2004-340671.

Among them, Japanese Patent Laid-Open Publication No. 2002-129139 discloses a color-changing time-lapse indicator having a color-changing ink layer which is changed in color in response to the temperature and/or humidity as well as the elapsed time, and a non-color-changing ink layer on a substrate, wherein the indicator has an isolation layer isolating the substrate from the color-changing ink layer and the non-color-changing ink layer and the color-changing ink layer and non-color-changing ink layer are formed on the isolation layer so that a part or whole of the color-changing ink layer is exposed to the outside air. A prepared cyanine dye (C.I. Basic Red 37) is used in the color-changing ink and only Example at +20° C. is exemplified.

Japanese Patent Laid-Open Publication No. 2003-342428 discloses an indicator using a resin composition having a response to the humidity or the temperature, which is produced by blending 90 to 10% by weight of an ethyelene-vinyl acetate copolymer or a partially saponified product of a polyvinyl acetate (resin B) relative to 10 to 90% by weight of a mixture of ethylene-α, β-unsaturated carboxylic acid copolymer or an ion-crosslinked product thereof (resin A) with a hygroscopic organic compound (compound A) It is described that when the indicator was maintained at a temperature of 80 to 110° C. for a few seconds, it changed its color from the initial color of transparence to an opaque color.

Japanese Patent Laid-Open Publication No. 2004-340671 discloses a temperature history indicator for discriminating the length of time in which the indicator has been exposed to a set temperature condition, which has a structure comprising: a dye layer containing a dye which diffuses and transfers during the period of being exposed to the set temperature condition; a dye diffusion controlling layer controlling the diffusion and transfer speed of the dye from the dye layer; and a color developing layer which is dyed with the dye diffusing and transferring through the dye diffusion controlling layer from the dye layer to increase the developed-color concentration with time; these layers being laminated on one surface of a substrate in this order from the substrate. It is described that the temperature history indicator can discriminate the length of time in which the indicator has been exposed to a set temperature condition from the difference in the developed-color concentration due to the difference in the heating time, when the indicator has been maintained at a temperature of 60° C. for 2 to 4 weeks.

In this way, conventionally, neither description nor suggestion has been made for a temperature history indicator suitable for controlling the temperature history of individual goods refrigerated and preserved under various temperature conditions even by referring to any one of the above patent publications. For example, for goods which are preserved in a refrigeration temperature range of approximately −10° C. to +10° C., for example a food which is suitably preserved at a temperature range of approximately 0 to +5° C., this temperature history indicator is capable of visually, securely (accurately) and easily detecting the temperature history of whether the food was subjected to a high temperature condition (for example, +15° C.) unsuitable for the preservation of the food during the preservation and storage of the food, and is capable of easily controlling goods without fear of the contamination of goods such as foods, and is excellent in safety and the like.

### SUMMARY OF THE INVENTION

The present invention is intended to solve the above-mentioned problems associated with the prior arts. An object of the present invention is to provide a temperature history indicator suitable for controlling the temperature history of individual goods refrigerated and preserved under various temperature conditions. For example, for foods (for example, raw animal meats, fresh seafood and processed vegetables) preferably preserved at a refrigeration temperature range of approximately −10° C. to +10° C, this temperature history indicator is capable of securely and easily detecting the temperature history of whether the goods were subjected to an unsuitable high temperature condition leading to a quality deterioration of the goods, for example, at +15° C., or further elevated temperature at +20° C. during the preservation and storage of the goods, and is capable of easily controlling the goods at a low cost and is excellent in safety and the like.

Another object of the present invention is to provide a temperature history indicator set which is capable of easily and securely controlling the temperature history by using the above-mentioned temperature history indicator.

Still another object of the present invention is to provide an easy and secure method of controlling a temperature history in the temperature range of preferably −10° C. to +10° C. by using the above-mentioned temperature history indicator.

The temperature history indicator according to the present invention comprises an oxygen detecting agent main body, which is changed in color in response to the oxygen concentration and a slightly gas-permeable packaging film for sealing and coating the oxygen detecting agent main body.

In the present invention, the packaging film desirably has an oxygen permeability (measured by an oxygen permeation instruments, OX-TRANS2/21 Series MD Type, manufactured by Mocon Corp.) of 0.1 to 50 ml/m².day, preferably 0.3 to 30 ml/m².day at a temperature of 25° C.

In the present invention, the packaging film is desirably a laminated film produced by laminating and bonding (adhering) two or more films (or layers) each consisting of any one polymer selected from polyethylene terephthalate (PET), polyacrylonitrile (PAN), polyamide (NY) and polyethylene (PE). When necessary, each of the above-mentioned laminated films or a film for each layer constituting each laminated film may be biaxially stretched.

In the present invention, the oxygen detecting agent main body is desirably a carrier having an aqueous solution supported thereon, wherein the aqueous solution contains a reductive saccharide, an alkali metal compound and a dye which is reduced by a reductive saccharide to be identifiably changed in color.

In the present invention, further, the oxygen detecting agent main body desirably comprises a dye which is not reduced by the reductive saccharide.

The temperature history indicator set according to the present invention comprises any one of the above-mentioned temperature history indicators and a color sample showing the relationship between temperature and change in color tone with time.

A method of controlling a temperature history of goods according to the present invention is characterized in that the temperature history of goods is controlled by utilizing any one of the above-mentioned temperature history indicators which is identifiably changed in color in response to the oxygen concentration (also irreversibly with time) in the temperature range of at least −10° C. to +10° C., or the above-mentioned temperature history indicator set.

According to the present invention, there is provided a temperature history indicator suitable for controlling temperature history of individual goods refrigerated and preserved under various temperature conditions at a low cost. For example, for foods suitably preserved at a temperature of approximately −10° C. to +10° C., this temperature history indicator is capable of visually, securely and easily detecting the temperature history of whether the food was subjected to a temperature condition unsuitable for the quality control during the preservation and storage of the food, for example, in the range of from 0° C. (elevated by 15° C.) to approximately +15° C. or further more, and is capable of easily controlling goods and is excellent in safety and the like.

Further, a temperature history can be easily and securely controlled by the temperature history indicator set according to the present invention.

Furthermore, according to the present invention, there is provided an easy and secure method of controlling the temperature history of various goods in the temperature range of approximately −10° C. to +10° C. using the above-mentioned temperature history indicator at a low cost. By the method of controlling a temperature history using such a temperature history indicator, for example in the case of controlling the temperature history of foods, such as raw animal meats, fresh seafood and processed vegetables over a relatively short period of time, such as approximately a few days to a week, a remarkable color change with time or in response to a temperature change is exhibited in the temperature history indicator and a changed color of the temperature history indicator does not return to an original color even when the temperature of foods returns to the original temperature, so that the temperature history indicator of the present invention can be suitably applied to the temperature history control in the fields of drugs and medical supplies, printing inks and electricity, machinery and appliances as in the case of fresh meats.

### BRIEF DESCRIPTION OF THE DRAWINGS

FIG. 1 is a schematic sectional view showing an embodiment of a temperature history indicator according to the present invention.

FIG. 2-1 is a table showing the relationship between the used temperature and a-value of a temperature history indicator (B, No. 5) of the present invention described in preparation example 1.

FIG. 2-2 is a graph showing the relationship between the used temperature and a-value of a temperature history indicator (B, No. 5) of the present invention described in preparation example 1.

FIG. 3-1 is a table showing the relationship between the used temperature and a-value of a temperature history indicator (D, No. 7) of the present invention described in preparation example 2.

FIG. 3-2 is a graph showing the relationship between the used temperature and a-value of a temperature history indicator (D, No. 7) of the present invention described in preparation example 2.

FIG. 4-1 is a table showing the relationship between the used temperature and a-value of a temperature history indicator (E, No. 9) of the present invention described in preparation example 3.

FIG. 4-2 is a graph showing the relationship between the used temperature and a-value of a temperature history indicator (E, No. 9) of the present invention described in preparation example 3.

FIG. 5-1 is a table showing the relationship between the used temperature and a-value of a temperature history indicator (No. 1) of the present invention described in preparation example 4.

FIG. 5-2 is a graph showing the relationship between the used temperature and a-value of a temperature history indicator (No. 1) of the present invention described in preparation example 4.

FIG. 6-1 is a table showing the relationship between the used temperature and a-value of a temperature history indicator (No. 2) of the present invention described in preparation example 5.

FIG. 6-2 is a graph showing the relationship between the used temperature and a-value of a temperature history indicator (No. 2) of the present invention described in preparation example 5.

FIG. 7-1 is a table showing the relationship between the used temperature and a-value of a temperature history indicator (No. 3) of the present invention described in preparation example 6.

FIG. 7-2 is a graph showing the relationship between the used temperature and a-value of a temperature history indicator (No. 3) of the present invention described in preparation example 6.

FIG. 8-1 is a table showing the relationship between the used temperature and a-value of a temperature history indicator (No. 4) of the present invention described in preparation example 7.

FIG. 8-2 is a graph showing the relationship between the used temperature and a-value of a temperature history indicator (No. 4) of the present invention described in preparation example 7.

FIG. 9-1 is a table showing the relationship between the used temperature and a-value of a temperature history indicator (No. 6) of the present invention described in preparation example 8.

FIG. 9-2 is a graph showing the relationship between the used temperature and a-value of a temperature history indicator (No. 6) of the present invention described in preparation example 8.

FIG. 10-1 is a table showing the relationship between the used temperature and a-value of a temperature history indicator (No. 8) of the present invention described in preparation example 9.

FIG. 10-2 is a graph showing the relationship between the used temperature and a-value of a temperature history indicator (No. 8) of the present invention described in preparation example 9.

### DESCRIPTION OF THE PREFERRED EMBODIMENTS

Hereinafter, the temperature history indicator according to the present invention will be explained in detail with reference to drawings.

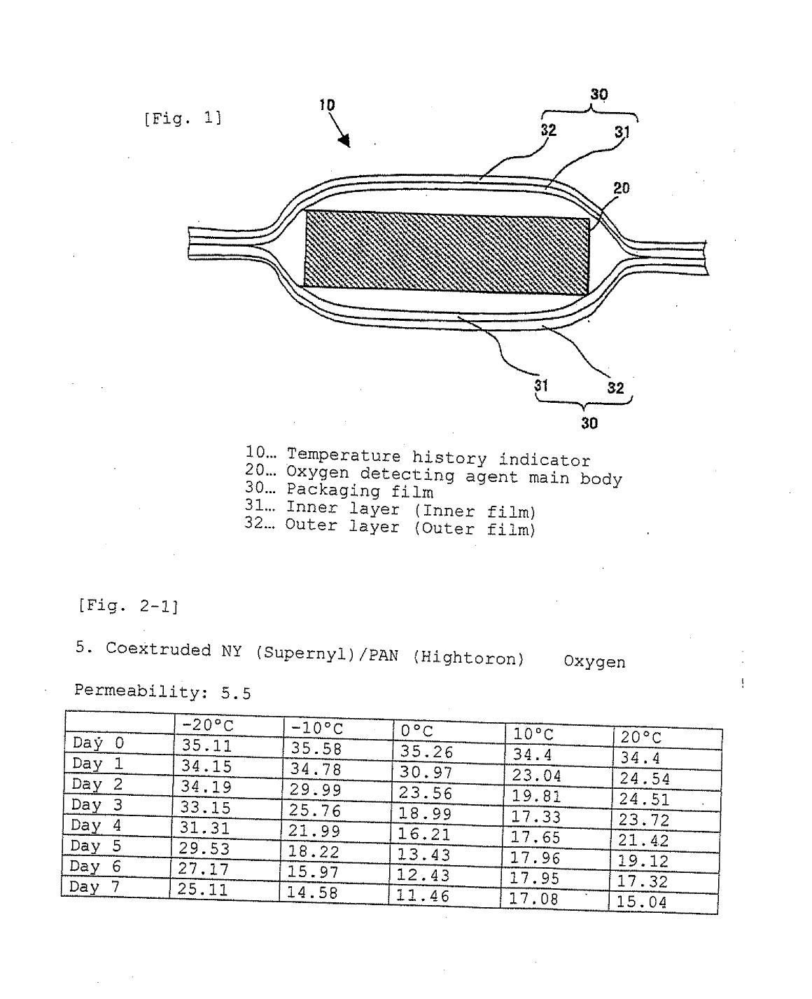

The numbering 10 in FIG. 1 is a schematic sectional view showing a suitable embodiment of the temperature history indicator according to the present invention.

<Temperature History Indicator 10>

The suitable temperature history indicator 10 of the present invention shown in FIG. 1 is an indicator comprising the oxygen detecting agent main body 20 and the slightly gas-permeable packaging film 30 for sealing and coating the oxygen detecting agent main body 20.

A temperature history indicator according to the present invention is characterized in that, in case of preserving raw animal meats, fresh seafood, processed vegetables and processed foods (for example, raw noodles and box lunches) which are desirably preserved and controlled in a display case for retail sales at approximately −5° C. to +5° C. for a short period of time, such as approximately a few days to a week, or of preserving fresh vegetables and fruits and the like (hereinafter, the above goods are also collectively referred to as “raw animal meats and the like”) which are desirably preserved and controlled in the temperature range of approximately 0° C. to +10° C. for a predetermined period of time, because the quality deterioration may remarkably proceed in a short period of time if the preservation temperature is elevated from a storage and preservation temperature of approximately −5° C. (or lower), at which raw animal meats and the like can be freshly preserved for the above-mentioned period of time and the quality deterioration thereof is extremely unlikely to occur, to approximately +15° C., the presence of such a fact (a temperature history during the preservation of raw animal meats and the like) that, for example the preservation temperature was elevated from a preferred temperature range of approximately −5° C. to +5° C., to +15° C. at which the quality of raw animal meats and the like may deteriorate in a short period of time, can be easily and securely monitored with the naked eye.

That is to says as the packaging film 30 in the temperature history indicator of the present invention, there is selected a film material in which the gas permeability is remarkably increased when the temperature is elevated, preferably in the temperature range of −10° C. to +10° C.

In addition, there is used the oxygen detecting agent main body 20, in which the color of the oxygen detecting agent main body 20 is changed perceptible with the naked eye, easily and securely in response to the concentration of a gas such as oxygen (that is, the oxygen detecting agent main body 20 in which no color return accompanying the temperature change occurs and the color is irreversibly changed), when the oxygen detecting agent main body 20 is sealed and coated with the above film material.

The temperature history indicator of the present invention adopts the above structure so that the temperature history can be easily and securely monitored in the low temperature preservation of raw animal meats and the like.

In more detail, for example, there can be mentioned an embodiment in which the packaging film 30 of the temperature history indicator of the present invention comprises a coextruded polyamide (NY)/polyacrylonitrile (PAN) laminated film, and the oxygen detecting agent main body 20 is described in Examples 3 and 4 (on page 3, from lower left column to lower right column) of Japanese Patent Laid-Open Publication No. S63-243754.

The oxygen detecting agent main body 20 described in Examples 3 and 4 of Japanese Patent Laid-Open Publication No. S63-243754 is “the oxygen detecting agent main body 20 which is obtained by impregnating a filter paper with a mixture prepared by mixing 13 parts by weight of a 0.5% methylene blue aqueous solution, 13 parts by weight of a 0.25% Safranine T aqueous solution, 65 parts by weight of 30% D-glucose and 9 parts by weight of a 15% potassium hydroxide aqueous solution” ([Example 3] in the above patent publication) In addition, the oxygen detecting agent main body 20 may be obtained subsequently by vacuum drying the above-obtained filter paper to remove unnecessary moisture when necessary ([Example 4] in the above patent Document). The oxygen detecting agent main body 20 turns to a pink color when maintained in a nitrogen atmosphere (the oxygen concentration: 0.1% or less) and develops a blue color when an oxygen gas having an oxygen concentration more than the above concentration flows into the atmosphere.

In the present invention, the oxygen detecting agent main body 20 described in Example 3 (or Example 4) in the above patent publication is sealed and coated, for example, with the above coextruded polyamide (NY)/polyacrylonitrile (PAN) laminated film (B) which is significantly different in gas permeability depending on the temperature and is a kind of the slightly gas-permeable packaging film 30, in a nitrogen atmosphere (for example, the oxygen concentration is 0.1% or less). The temperature history indicator produced by combining the laminated film (B) with the oxygen detecting agent main body 20 maintains a pink color even when it is maintained at the same temperature (−20° C.) in a nitrogen atmosphere (oxygen concentration: 0.1% or less) for 5 days.

However, when the temperature of the laminated film (NY/PAN) is elevated in the temperature range of at least −20° C. to 0° C., the gas permeability thereof is remarkably increased and the difference in the oxygen permeability (cc/m².day) according to the temperature change is significantly large. For example, when it is maintained at 0° C. for 5 days, an oxygen gas having an oxygen concentration of more than the above-mentioned concentration (0.1%) flows into the oxygen detecting agent main body 20 through a pore of the slightly gas-permeable packaging film 30 to turn the main body to a blue color, and thus the color-changed main body can be clearly identified from the original main body having a pink color and as the difference in the amount of color change, the difference of a-value in the Hunter's Lab color specification method (lab value) is approximately 10.8.

In other words, in the case of preserving foods and the like for 5 days, if the temperature history indicator maintains a pink color still on the fifth day from the start of storage, it shows that they have been continuously refrigeration-preserved at approximately −20° C. or lower, and if the indicator turns to a blue color, it shows that they have been preserved at least at approximately 0° C. for a few days (for example, five days) or at the temperature more than that (more than 0° C.) for a time period of less than 5 days.

In the present invention, particularly it is preferred to provide a color sample showing the relationship between the temperature and the color tone change with time as a set with the temperature history indicator of the present invention because judging the temperature history is easy and secure.

Hereinafter, there will be explained the oxygen detecting agent main body 20, the packaging film 30 for sealing and coating the oxygen detecting agent main body 20 which constitute the temperature history indicator of the present invention, a production method of the temperature history indicator and a method of using thereof and the like sequentially in this order.

<Oxygen Detecting Agent Main Body 20>

There is used the oxygen detecting agent main body 20, which is changed in color in response to the change in the oxygen concentration. More specifically, there is preferably used the oxygen detecting agent main body 20, in which the change amount of the gas permeability is remarkably large in the temperature range of at least the above −20° C. to +20° C., preferably −10° C. to +10° C., and moreover the change amount of the gas permeability in such a temperature range can be clearly visibly identified as a difference in color.

As such an oxygen detecting agent main body 20, preferably used is an “oxygen detecting agent main body” described in [0038] to [0046] in Japanese Patent Laid-Open Publication No. 2004-254684 or a “sheet-shaped oxygen detecting agent” described in Japanese Patent Laid-Open Publication No. S63-243754 in that they are changed largely in color in response to the oxygen concentration change in the case of using the above-mentioned film, and thus are excellent in visibility.

That is, for example, there is used the oxygen detecting agent main body, which is capable of detecting the oxygen concentration and the presence or absence of oxygen inside and outside of the packaging containers of foods and the like by detecting the oxygen concentration and the presence or absence of oxygen permeating or penetrating through a control film of the oxygen permeability, and particularly detecting that the oxygen is fully removed or is in a critical concentration by gas-replacing the inside of the package when a gas-replaced packaging or an oxygen-free packaging is used, and indicates the oxygen concentration and the presence or absence of oxygen by the change in color, that is, the change in hue, color or brightness.

In order to prevent the misuse of the oxygen detecting agent main body and make the quality control adequate, to the oxygen detecting agent main body, is preferably attached a color sample comprising: at least a color showing the initial state before the oxidation of the oxygen detecting agent main body; a color showing the temperature state exceeding the upper limit for maintaining the quality; and a color showing a state within a temperature range for maintaining the quality when necessary, as well as a display explaining the condition of each food and the like respectively corresponding to the changed color (for example, blue color of methylene blue) or to the unchanged color (for example, pink color of Safranine T or red food dye) of the oxygen detecting agent main body; and a display of the kind of foods of which quality is to be controlled by the oxygen detecting agent main body, or of the quality control conditions (such as a preservation temperature and preservation time of the foods or a packaging condition such as a vacuum sealing and a gas-replaced packaging), wherein the color sample is integrally or separately attached to the oxygen detecting agent main body as a set.

The oxygen detecting agent main body includes those obtained by impregnating a porous member, such as a molded product in a tablet form, papers, strings, absorbent cottons, porous resins, porous inorganic materials or porous inorganic oxides with an oxygen detecting composition solution and by drying the resultant impregnation product when necessary, those obtained by applying an oxygen detecting composition to the surface of a paper or a film and by drying the resultant paper or film when necessary and those obtained by printing the composition.

Particularly, for the applications where light resistance is required, for example an indicator for the quality control of meats and the like displayed on a bright display shelf for a few days, preferably used is a porous member, such as porous inorganic oxides which will be described later, from the viewpoint that the color tone is more advantageously maintained after the color change of the oxygen detecting agent main body.

As the oxygen detecting composition, a conventionally known one may be used, but there is preferably used a so-called redox type oxygen detecting composition. As a representative redox type oxygen detecting agent, there can be mentioned a combination of a specific dye such as methylene blue which is reduced by reductive saccharides to be identifiably changed in color and glucose and the like as a reducing agent for reducing the dye (refer to Japanese Patent Laid-Open Publication No. 2000-39429, Japanese Patent Laid-Open Publication No. S53-120493, Japanese Patent Laid-Open Publication No. S56-60349 and Japanese Patent Laid-Open Publication No. S63-243754). The above-mentioned oxygen detecting agent utilizes such a phenomenon that when oxygen is present, the oxygen detecting agent exhibits a blue color by oxidizing methylene blue per se, but the above dye which has developed a blue color is reduced with a reducing agent, such as glucose in the absence of oxygen (oxygen which has oxidized the dye is deprived by glucose and then glucose per se is oxidized) to become colorless. In general, a dye (for example, a red dye, such as food red dye) is incorporated so that this phenomenon is clearly emphasized to distinguish when methylene blue has become colorless.

Particularly, in the present invention, the oxygen detecting agent main body is preferably a “sheet-shaped oxygen detecting agent” described in Japanese Patent Laid-Open Publication No. S63-243754, that is, “a carrier in a sheet form having an aqueous solution supported thereon, wherein the solution contains a reductive saccharide (a), an alkali metal compound (b) and a dye (c-1) which is reduced by a reductive saccharide to be identifiably changed in color” in terms of visibility, safety and the like. Examples of the reductive saccharide of the component (a) include monosaccharides, such as D-glucose and polysaccharides, such as maltose, and examples of the component (b) include hydroxides and carbonates of Na and Ca and the like Examples of the component (c-1) include methylene blue, new methylene blue, Rouse violet, methyelene green and the like and particularly preferred is methylene blue in terms of visibility.

Further, the oxygen detecting agent main body may contain a dye (c-2) which is not reduced by the reductive saccharide (a) in addition to the dye (c-1) as described in the above patent publication. Because the reductive dye (c-1) becomes colorless in a reduced state and is sometimes difficult to judge with the naked eye when the reductive dye (c-1) is methylene blue and the like, the presence or absence of oxygen is visually judged more easily and accurately by the non-reductive dye (c-2). Examples of the dye (C-2) which is not reduced by the above reductive saccharides include Safranine T, phenosafranine and the like. Examples of the sheet-shaped carrier include ion exchange resins, cellulosic materials, organic macromolecular compounds and the like.

Among the above porous members, examples of the porous inorganic material include activated carbons, charcoals, bone charcoals and the like. In addition, examples of the porous inorganic oxide include oxides of silicon (Si), aluminum (Al), magnesium (Mg), calcium (Ca), Zinc (Zn), barium (Ba), potassium (K), a mixture thereof and a complex oxide containing the above elements.

More specifically, examples of the porous inorganic oxide include silica gel, silica, zeolite, moldenite, bentonite, montmorinite, (active) alumina, magnesium, titania, active white clay, clay, slug, bauxite, porous glass beads and the like.

Among these porous members, preferred are porous inorganic oxides and further preferred are silica gel, alumina, zeolite and moldenite in terms of light resistance, visibility of color tone change, safety and the like of the oxygen detecting agent obtained therefrom.

These porous members can be used individually or in combination of two or more kinds.

<Packaging Film 30>

The packaging film 30 is used for sealing and coating the oxygen detecting agent main body 20. It is necessary that the packaging film has a slight gas permeability and the gas (for example, oxygen gas) permeability varies depending on the temperature, and is significantly changed when the temperature is changed in the range of at least approximately −10° C. to +10° C. The present invention is characterized in that there is combined the packaging film 30 in which the oxygen gas permeability is increased according to the lapse of the goods storage days (preferable example: approximately 3 to 7 days) and the temperature elevation at least in the above temperature range, with the oxygen detecting agent main body 20 which is changed in color sensitively to be visibly identifiable in response to the change in the gas permeability (amount) of the packaging film 30.

In the present invention, the packaging film 30 is a laminated film comprising two or more kinds of polymers (or films thereof) selected from the group consisting of polyethylene terephthalate (PET), polyacrylonitrile (PAN), polyamide (NY) and polyethylene (PE), wherein the above each laminated film or a film for each layer constituting each laminated film may be biaxially stretched. In other words, the above laminated film is produced by laminating and bonding (adhering) two or more kinds of films (or layers) each comprising any one polymer of PET, PAN, NY and PE.

More specifically, the packaging film 30 preferably is an unstretched laminated film selected from the group consisting of a laminated film comprising (A) polyethylene terephthalate (PET)/polyacrylonitrile (PAN) as the laminate structure, a laminated film comprising (B) polyamide (NY)/polyacrylonitrile (PAN) as the laminated structure and a laminated film comprising (C) polyamide (NY)/polyethylene terephthalate (PET) as the laminated structure, or

a laminated film having a biaxially stretched layer selected from the group consisting of (D) a laminated film comprising biaxially stretched polyamide (ONY)/PAN as the laminated structure and (E) a laminated film comprising biaxially stretched polyamide (ONY)/PET as the laminated structure. In addition, as the above unstretched laminated film, (F) a laminated film comprising polyamide (NY)/polyethylene (PE) as the laminated structure can be also used.

In a preferred embodiment of the present invention, it is desired that the above packaging film 30 is (B) a polyamide (NY)/polyacrylonitrile (PAN) laminated film, (D) a biaxially stretched polyamide (ONY)/PAN laminated film or (E) a biaxially stretched polyamide (ONY)/PET laminated film since when the packaging film 30 is combined with a specific oxygen detecting agent main body 20 used in the present invention, the oxygen detecting agent main body 20 has a large change in color (difference in a-value) due to the difference of the temperature, and moreover, in the case of preserving and storing fresh foods for a short period of time (approximately 3 to 7 days) in a refrigeration range (preferably −10° C. to +10° C.), the color of the oxygen detecting agent main body is not returned even when the temperature is fluctuated in the above temperature range, so that the control of the temperature history of goods becomes accurate and easy.

In the present invention, in an embodiment using the packaging film 30, any one of the layers in the above laminated films may be an inner layer, but in order that the heat-seal temperature of the film becomes lower and the bonding strength becomes higher, for example, in the PET/PE laminated film, the PET and PE layers may be bonded together so that the PE layer having a melting point lower than that of the PET layer is an inner layer (seal face), and the other laminated films are the same.

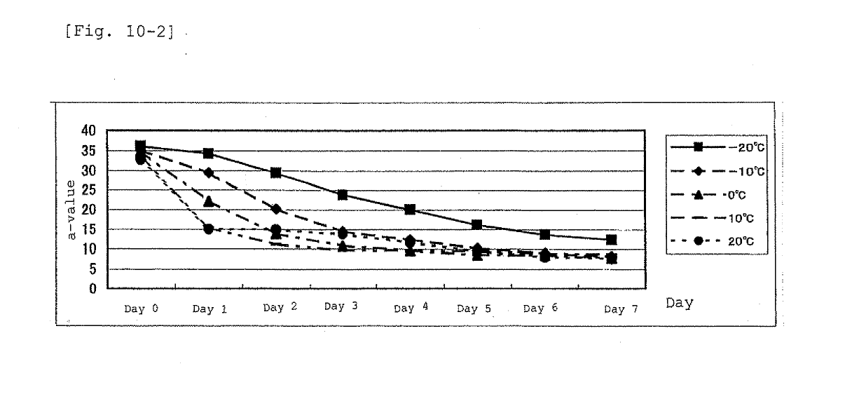

As such a laminated film, for example, there can be mentioned a PET/PAN laminated film (A) having a thickness of 12 μm/30 μm and an oxygen permeability (at 25° C.) of approximately 6.0 cc/m².day (FIG. 10-1 and FIG. 10-2),

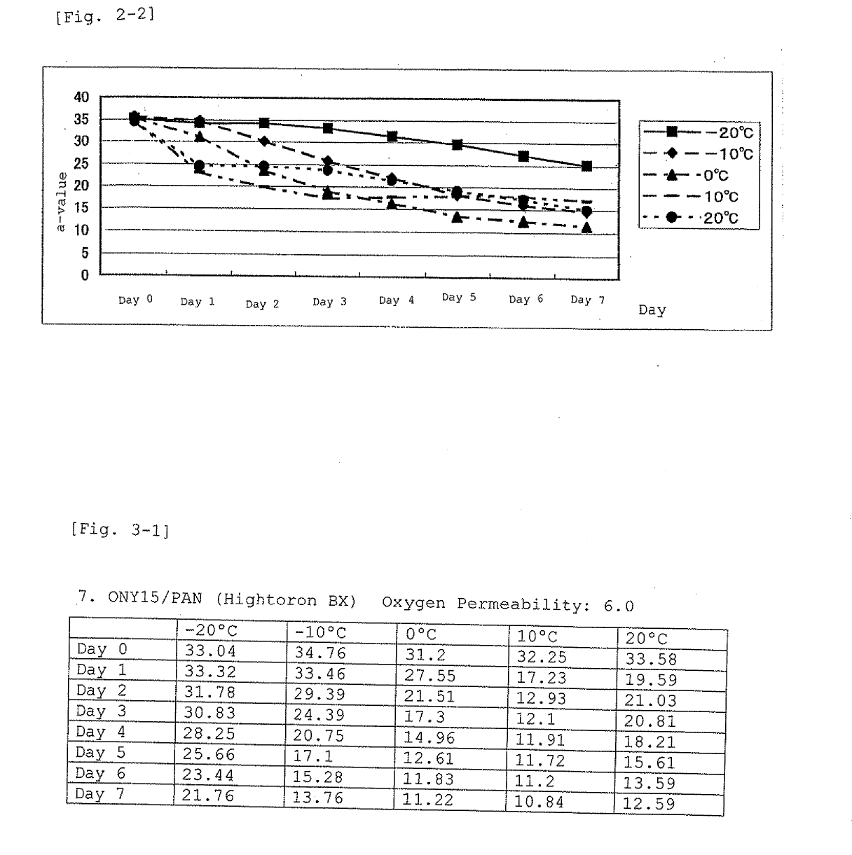

a coextruded polyamide (NY)/PAN laminated film (B) having a thickness of 15 μm/30 μm and an oxygen permeability (at 25° C.) of approximately 5.5 cc/m².day (FIG. 2-1 and FIG. 2-2),

a SiPET/PAN laminated film (C) having a thickness of 12 μm/30 μm and an oxygen permeability (at 25° C.) of approximately 0.5 cc/m².day (FIG. 1-1 and FIG. 1-2),

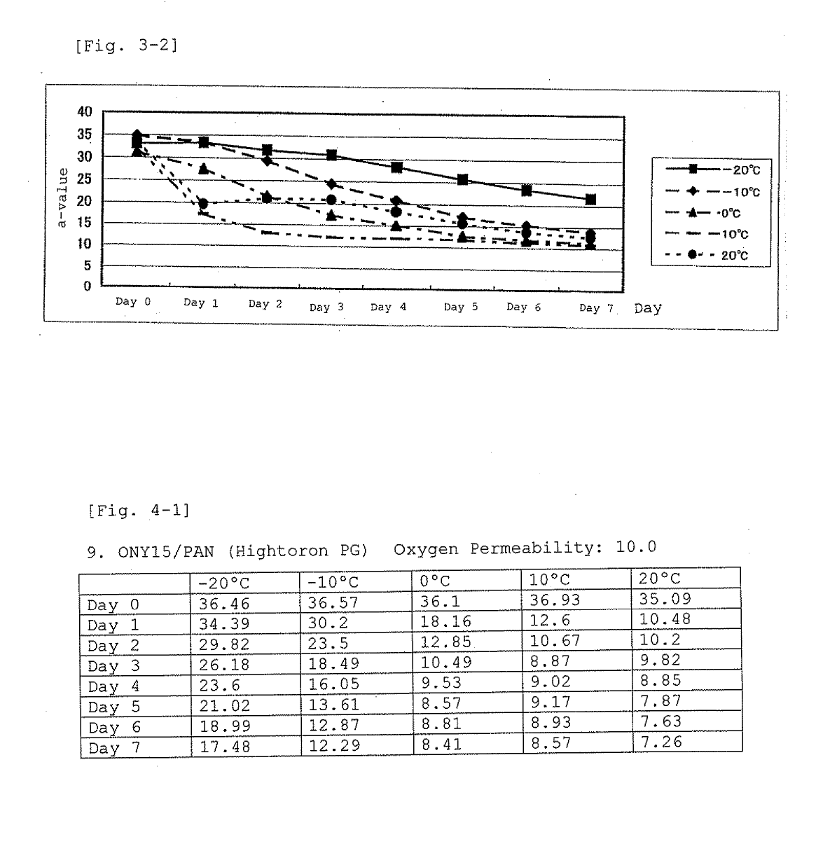

a biaxially stretched polyamide (ONY)/PAN laminated film (D) having a thickness of 15 μm/30 μm and an oxygen permeability (at 25° C.) of approximately 6 cc/m².day (FIG. 3-1 and FIG. 3-2), and

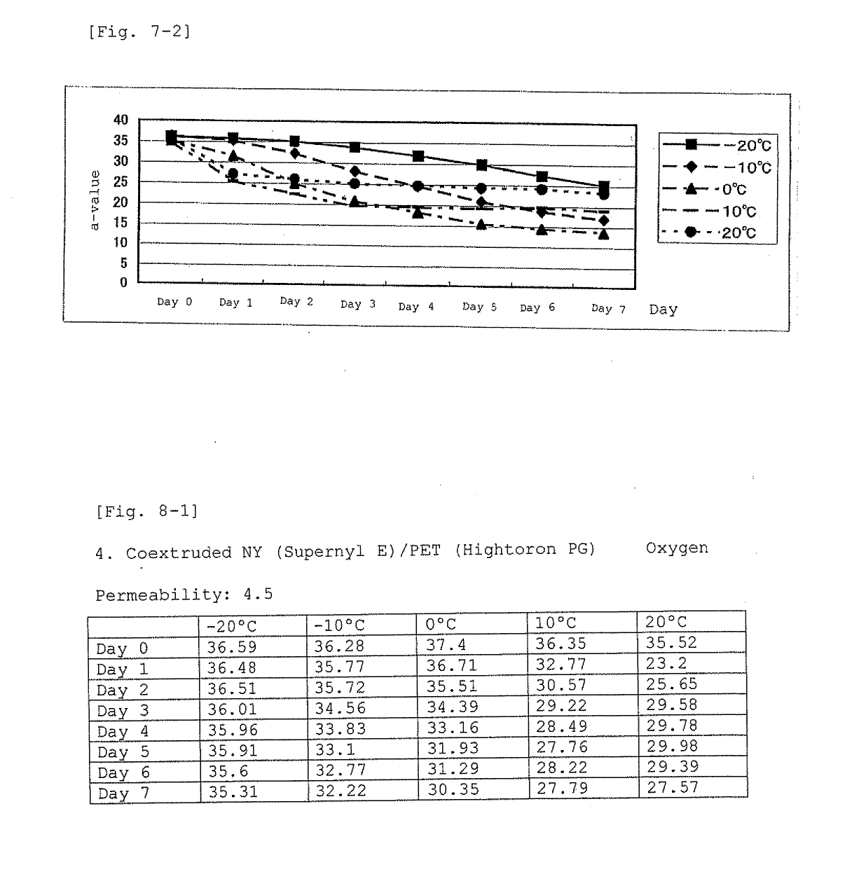

a KPET/PAN laminated film having a thickness of 12 μm/30 μm and an oxygen permeability (at 25° C.) of approximately 3.5 cc/m².day (FIG. 7-1 and FIG. 7-2).

Further, as a base film (material) for forming the above laminated films, with respect to the unstretched film material, examples of the polyacrylonitrile (PAN) film include “Hightoron BX” (manufactured by TAMAPOLY Co., Ltd., thickness: 30 to 40 μm) and the like, and examples of the polyamide film material include “Supernyl” (manufactured by Mitsubishi Plastics Inc., a polyamide film, thickness: 15 to 25 μm) and the like, and examples of the polyethylene terephthalate (PET) film include “Hightoron PG” (manufactured by TAMAPOLY Co., Ltd.) and the like.

In the biaxially stretched film, examples of the polyethylene terephthalate (PET) film include “Diafoil H105” (manufactured by Mitsubishi Polyester Film GmbH, a biaxially stretched polyester film, thickness: 12 to 25 μm)

Preferably used as a base material film are “K-PET (generic name)” (trade name: “Senesee KET”, manufactured by Daicel Value Coating Ltd., a PVDC-coated biaxially stretched polyester film, thickness: 12 to 16 μm) and the like.

In addition, examples of the SiPET film include “TECHBARRIER” (manufactured by Mitsubishi Plastics Inc., a transparent biaxially stretched polyester film on one side on which an amino group-containing silane coupling agent layer is disposed, thickness: approximately 12 μm), and examples of the biaxially stretched polyamide film (material) (ONY) include “SANTONYL” (manufactured by Mitsubishi Plastics Inc., a MXD-based coextruded, biaxially stretched polyamide film, thickness: 15 to 25 μm) and the like.

If the packaging film 30 is any of the above, preferably any of NY/PAN (B), ONY/PAN (D) or ONY/PET (E) and especially ONY/PET (E), it is desirable in that it is excellent in visibility of the temperature history in the temperature range of at least 0° C. to −20° C., because when it is used in combination with the oxygen detecting agent main body 20 which is suitable as the oxygen detecting agent main body 20 and is described in examples 3 and 4 in said Japanese Patent Laid-Open Publication No. S63-243753, a large difference in a-value “the difference in a-value in the Hunter's Lab color specification method (Lab value)” is obtained in response to the temperature history, the gas permeation with time is low in the range of −20° C. to a higher temperature elevated by a few degree from −20° C., the color of the oxygen detecting agent main body 20 is not changed to become visible and the color of the oxygen detecting agent main body 20 may be significantly changed to become identifiable when the temperature is raised to −10° C. and further to 0° C.

In this way, these packaging films 30 have a characteristic that they have a relatively slight gas permeability among the laminated films comprising combining commercially available various film materials and the gas permeability is significantly increased if the temperature is raised in the temperature range of at least 0° C. to −20° C.

For example, as shown in Preparation Example 7 (ONY/PAN (D)) of the present invention, the gas permeability is significantly increased (to the degree that it can be fully identified by the color change of the oxygen detecting agent main body 20) in case of a higher temperature of −10° C. and further 0° C., compared to that of a gas (for example, oxygen gas) in case of −20° C. As the result, the amount of color change of the oxygen detecting agent main body 20 contained in said packaging film 30 is increased with the lapse of time (the number of days).

The packaging film 30 is suitable in that it is excellent in visual distinguishability of the temperature history, since as the color change amount of the temperature history indicator immediately after setting and maintaining at each temperature of 0° C. and −20° C., especially as the color change amount of the oxygen detecting agent main body 20 comprising the indicator, the difference in a-value in the Hunter's Lab color specification method (Lab value) is not more than 0.5, in other words, in the range of 0 to 0.5, and

the difference in said a-value in case of maintaining at each temperature mentioned above for 5 days is not less than 9.0.

By using a packaging film having a large difference in a-value due to the temperature in the present invention, for example, in storing foods at −20° C. for 5 days, if the temperature is improperly elevated to −10° C. or 0° C. during the storage, the color of the methylene blue-based oxygen detecting agent main body 20 is changed from a pink color to a pale bluish-purple color (at −10° C.) and further changed to a blue color (0° C.). If the color is changed to a blue color as the final color, no color reversion occurs and the color is maintained. Therefore, it can be identified at a glance that the foods are temporarily subjected to a temperature higher than −20° C. in at least 5 days, for example, by visually confirming the state on the fourth day.

In the above case, it is assumed that the temperature history indicator 10 (especially the packaging film 30 for said indicator) is used for 5 days in case of storing and controlling the meats and the like, but the packaging film 30 in the present invention is not particularly limited, for example, there may be obtained a temperature history indicator which may be used depending on the number of the days (for example, 5 days) when the low temperature history should be controlled by adjusting the gas permeability accordingly. In addition, the temperature history indicator may be arranged so as to control a long-term low temperature history by adjusting the sheet number of the packaging film 30 to 1 to 5 sheets appropriately and combining said packaging film 30 with a conventionally known optional film appropriately.

<Production of Temperature History Indicator>

The above-mentioned temperature history indicator according to the present invention may be produced by combining the conventionally known methods appropriately.

That is to say, the oxygen detecting agent main body 20 having any size is prepared in accordance with examples 3 and 4 of Japanese Patent Laid-Open Publication No. S63-243754.

The oxygen detecting agent main body 20 is sandwiched with above specific packaging film 30 material, for example, a coextruded polyamide (NY)/polyacrylonitrile (PAN) laminated film as shown in (B), especially preferably a biaxially stretched polyamide (ONY)/PAN laminated film as shown in (D), and the edges of PAN layers of the laminated films are heat-sealed or bonded each other by an adhesive and the like, that is, sealing and coating the oxygen detecting agent main body 20 with the laminated film 30 to obtain a temperature history indicator 10 according to the present invention as shown in FIG. 1.

Further, the oxygen detecting agent main body 20 may be maintained in a pink color (which represents a reduced state) by performing said sealing and coating operations under a nitrogen atmosphere (under the conditions where the oxygen concentration is not more than 0.1% and the oxygen detecting agent main body 20 is maintained in a pink color).

In addition, in the case of performing said sealing and coating operations in an atmosphere as a matter of course, and also even in the case of preparing a temperature history indicator under a nitrogen atmosphere as mentioned above, in a “sheet-shaped oxygen detecting agent” described in Japanese Patent Laid-Open Publication No. S63-243754, if an adequate amount of above-described reducing saccharides (a) is added in the oxygen detecting agent main body 20, even if the body 20 is initially oxidized under an oxygen atmosphere to change in color to blue, after sealing and then after a period of time at a predetermined temperature (for example, at −20° C. at which the oxygen permeated amount is small), the reduction reaction by the reducing agent in the oxygen detecting agent 20 is dominant compared to the oxidation reaction by oxygen passing through the packaging film 30 at said temperature and thus the sheet-shaped oxygen detecting agent is reduced to change in color to pink.

<Method of Using Temperature History Indicator>

A temperature history indicator according to the present invention may be used alone by attaching on the outer surface of a packaging bag for food or as a temperature history indicator set comprising the “temperature history indicator” and “color sample” showing the relationship between a temperature and a color tone change with a lapse of time by attaching on the outer surface of a packaging bag for food.

Especially, if used as a set, the identification by a comparative observation becomes easy and the temperature control also becomes easy.

### EXAMPLES

### Preparation Examples

Hereinafter, suitable examples and comparative examples of a temperature history indicator according to the present invention will be specifically explained further with reference to preparation examples 1 to 9, but the present invention is not limited by these preparation examples.

### Preparation Example 1

[Temperature History Indicator (No. 5)>

<(a) Preparation of Oxygen Detecting Agent Main Body 20>

An oxygen detecting agent main body 20 was prepared in accordance with examples 3 and 4 of Japanese Patent Laid-Open Publication No S63-243754.

That is, a mixed solution was prepared by mixing 13 parts by weight of a 0.5% methylene blue solution, 13 parts by weight of a 0.25% Safranine T solution, 65 parts by weight of 30% D-glucose and 9 parts by weight of a 15% potassium hydroxide solution and the resulting mixed solution was impregnated in a filter paper (“example 3” in the same patent application). In addition, thereafter, the filter paper was vacuum dried to remove the unnecessary moisture where necessary (“example 4” in the same patent publication).

The oxygen detecting agent main body 20 described in example 4 of this patent publication changed in color to pink when it was maintained under a nitrogen atmosphere (the oxygen concentration: not more than 0.1%) and developed a blue color when oxygen of more than the above concentration was entered.

<(b) Preparation of Packaging Film 30 (numbering (B)>

A coextruded polyamide/PAN laminated film shown by numbering (B) was prepared by a (two solution-based) dry laminate.

That is, said laminated film (B) was prepared by a dry laminate method by using “Supernyl” (produced by Mitsubishi Plastics Inc., thichkness: 15 μm) as a coextruded polyamide and “Hightoron BX” (produced by TAMAPOLY Co., Ltd., a polyacrylonitrile film, thickness: 30 μm) as a PAN film.

The laminated film (B) has an oxygen permeability (at 25° C.) [measured by an oxygen permeation instruments: OX-TRANS 2/21 Series MD Model, manufactured by Mocon Corp.] of 5.5 cc/m².day.

<(c) Production of Temperature History Indicator 10 (B)>

There was prepared the oxygen detecting agent main body 20 (example 3 of Japanese Patent Laid-Open Publication No. S63-243754) comprising impregnating a filter paper with the mixed solution prepared by the first step of the above process (a). At this time, the filter paper was a blue color. The oxygen detecting agent main body 20 was cut into a rectangle of 1.5×2.0 cm size and a laminated film of a “coextruded polyamide/PAN laminated film” (coextruded polyamide film, thickness: 15 μm/PAN film (thickness: 30 μm)) of 3.0×4.0 cm size was disposed so that the PAN layer was inside (31 in FIG. 1) and the edge of the first laminated film and the edge of the second laminated film were tightly overlapped and heat-sealed to seal the PAN layers of the first laminated film and the second laminated film each other to prepare a temperature history indicator.

<Inspection of Low Temperature History by Temperature History Indicator>

Subsequently, the temperature history indicator (B) was sealed together with a deoxidizer in a PVDC-coated NY/PET bag and then stored in an incubator at 35° C. As the result, 15 hours later, the filter paper in the temperature history indicator (B) turned to a pink color.

The temperature history indicators (color: pink color) were stored in incubators at +20° C., +10° C., 0° C., −10° C. and −20° C. and the color was measured each day by a color meter (“ZE2000” manufactured by Nippon Denshoku Industries Co., Ltd.).

Among the color measuring values, L*, a* and b*, for a*value (a-value) showing the color change amount of red-green, the change amount from the start of testing was evaluated.

The results are shown in FIG. 2-1 and FIG. 2-2.

▪ (Solid line) represents −20° C., ♦ (dashed line) −10° C., ▴ (chain line) 0° C., — (alternate long and short line) +10° C. and ● (dashed line) +20° C. in FIG. 2-2, respectively, and FIG. 2-2 is a graph with each line showing the change of the a-value in case of maintaining for 7 days (same in other figures).

As clearly shown in this graph (a-value), comparing the color of the temperature history indicator of the present invention with a predetermined color sample can tell how many days the foods and the like have been preserved at a constant low temperature (for example, a particular temperature in the range of approximately +10° C. to −10° C.).

### Preparation Example 2

[Temperature History Indicator (No. 7)>

A temperature history indicator was prepared similarly to preparation example 1 except that the following biaxially stretched polyamide (ONY 15)/polyacrylonitrile (PAN) laminated film (D) was used as the packaging film 30 in preparation example 1 and was tested in a similar way.

The results are shown in FIG. 3-1 and FIG. 3-2.

The details of preparation example 2 are as follows.

<(a) Preparation of Oxygen detecting Agent Main Body 20>

The oxygen detecting agent main body 20 was prepared in accordance with examples 3 and 4 of Japanese Patent Laid-Open Publication No. S63-243754.

That is, a mixed solution was prepared by mixing 13 parts by weight of a 0.5% methylene blue solution, 13 parts by weight of a 0.25% Safranine T solution, 65 parts by weight of 30% D-glucose and 9 parts by weight of a 15% potassium hydroxide solution and the resulting mixed solution was impregnated in a filter paper (“example 3” in the same patent publication). In addition, thereafter, the filter paper was vacuum dried to remove the unnecessary moisture where necessary (“example 4” in the same patent publication).

The oxygen detecting agent main body 20 described in example 4 of this patent publication changed in color to pink when it was maintained under a nitrogen atmosphere (the oxygen concentration: not more than 0.1%) and developed a blue color when oxygen of more than the above concentration was entered.

<(b) Preparation of Packaging Film 30 (numbering (D)>

A biaxially stretched polyamide (generic name: biaxially stretched polyamide (ONY)/PAN laminated film shown by numbering (D) was prepared by a (two solution-based) dry laminate.

Said laminated film (D) was prepared by a dry laminate method using “ONY15” having a thickness of 15 μm among “Santonyl” (produced by Mitsubishi Plastics Inc., biaxially stretched polyamide films, thickness: 15 to 25 μm) as the biaxially stretched polyamide (ONY) and a resin film having a thickness of 30 μm among “Hightoron BX” (produced by TAMAPOLY Co., Ltd., polyacrylonitrile-based resin films, thickness: 30 to 40 μm) as the PAN film.

The laminated film (D) has an oxygen permeability (at 25° C.) [measured by an oxygen permeation instruments: OX-TRANS 2/21 Series MD Model, manufactured by Mocon Corp.] of approximately 6 cc/m² day.

<(c) Production of Temperature History Indicator 10>

There was prepared the oxygen detecting agent main body 20 (example 3 of Japanese Patent Laid-Open Publication No. S63-243754) comprising impregnating a filter paper with the mixed solution prepared by the first step of the above process (a). At this time, the filter paper was a blue color. The oxygen detecting agent main body 20 was cut into a rectangle of 1.5×2.0 cm size and a laminated film of “ONY15” (a biaxially stretched polyamide film, thickness: 15 μm/PAN (30 μm thick)) of 3.0×4.0 cm size was disposed so that the PAN layer was inside (heat-sealed side) and the edge of the first laminated film and the edge of the second laminated film were tightly overlapped and heat-sealed to seal the PAN layers of the first laminated film and the second laminated film each other to prepare a temperature history indicator.

<Inspection of Low Temperature History by Temperature History Indicator>

Subsequently, the temperature history indicator was sealed together with a deoxidizer in a PVDC-coated NY/PE bag and then stored in an incubator at 35° C. As the result, 15 hours later, the filter paper in the temperature history indicator (B) turned to a pink color.

The temperature history indicators (color: pink color) were stored in incubators at a predetermined temperature similarly to preparation example 1 and the color was measured each day by a color meter.

The results are shown in FIG. 3-1 and FIG. 3-2.

### Preparation Example 3

[Temperature History Indicator (No. 9)>

A temperature history indicator was prepared similarly to preparation example 1 except that the following ONY (biaxially stretched polyamide)/polyethylene terephthalate (PET) laminated film (E) was used as the packaging film 30 in preparation example 1 and was tested in a similar way.

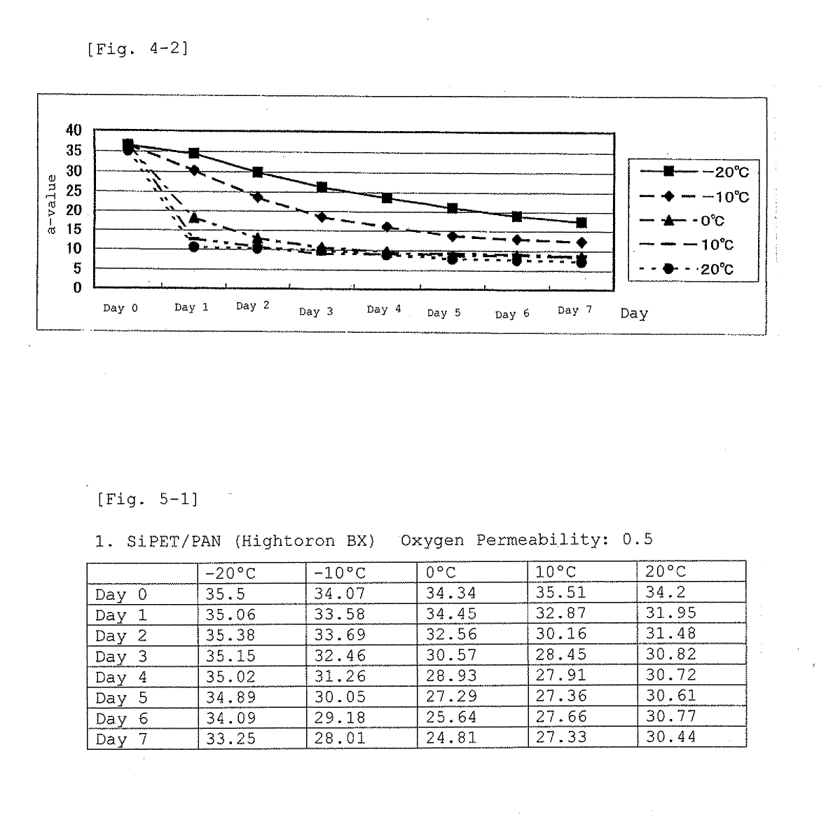

The results are shown in FIG. 4-1 and FIG. 4-2.

The details of preparation example 3 are as follows.

<(b) Preparation of Packaging Film 30 (Numbering (E)>

A biaxially stretched polyamide (generic name: biaxially stretched polyamide (ONY)/PET laminated film shown by numbering (E) was prepared by a (two solution-based) dry laminate.

Said laminated film (E) was prepared by a dry laminate method using “ONY15” having a thickness of 15 μm among “Santonyl” (produced by Mitsubishi Plastics Inc., biaxially stretched polyamide films, thickness: 15 to 25 μm) as the biaxially stretched polyamide (ONY) and a resin film among “Hightoron PG” (produced by TAMAPOLY Co., Ltd., thickness: 30 μm) as the PET film.

The laminated film (E) has an oxygen permeability (at 25° C.) of approximately 10 cc/m² day.

The operations other than the above-mentioned are the same as preparation example 1.

### Other Preparation Examples

[Temperature History Indicators (No. 1 to 4, 6 and 8)>

Said temperature history indicators No. 1 to 4, 6 and 8 were prepared similarly to preparation example 1 except that those shown in each Table were used as the laminated film.

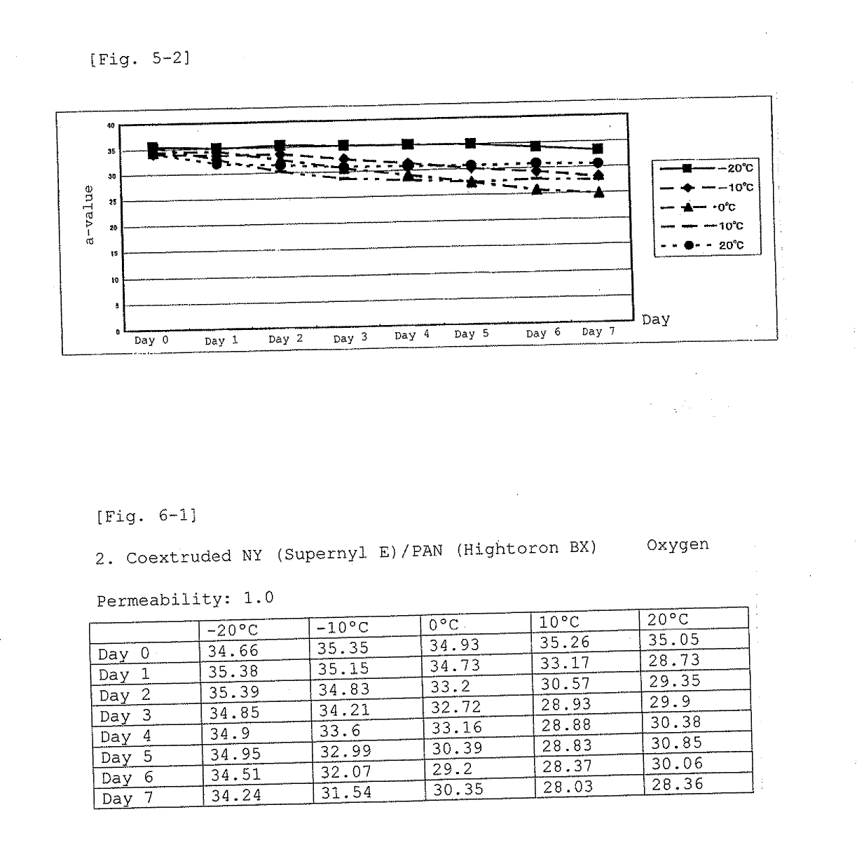

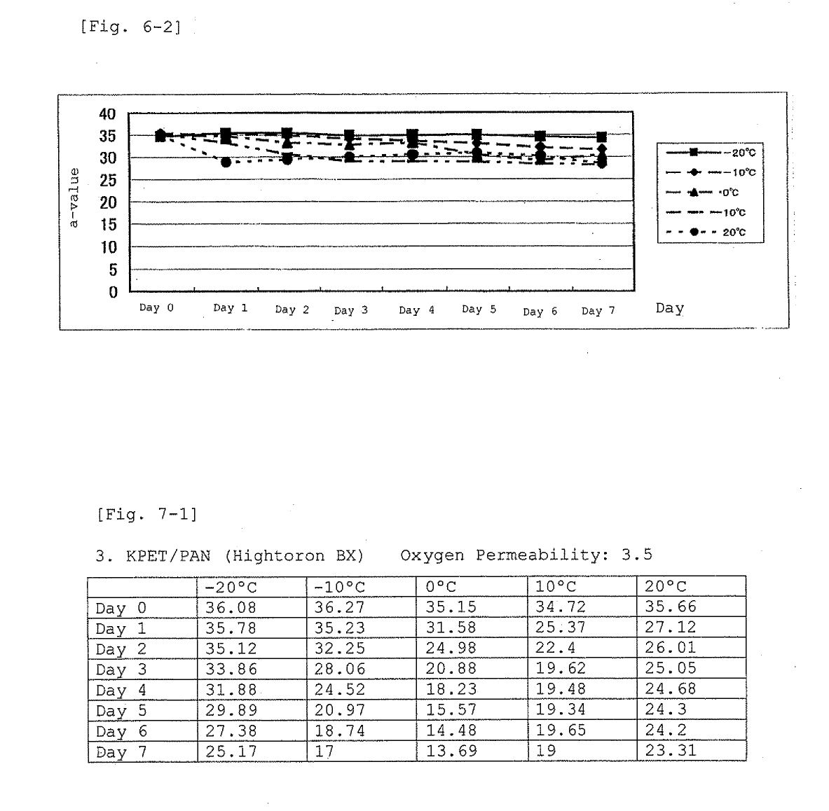

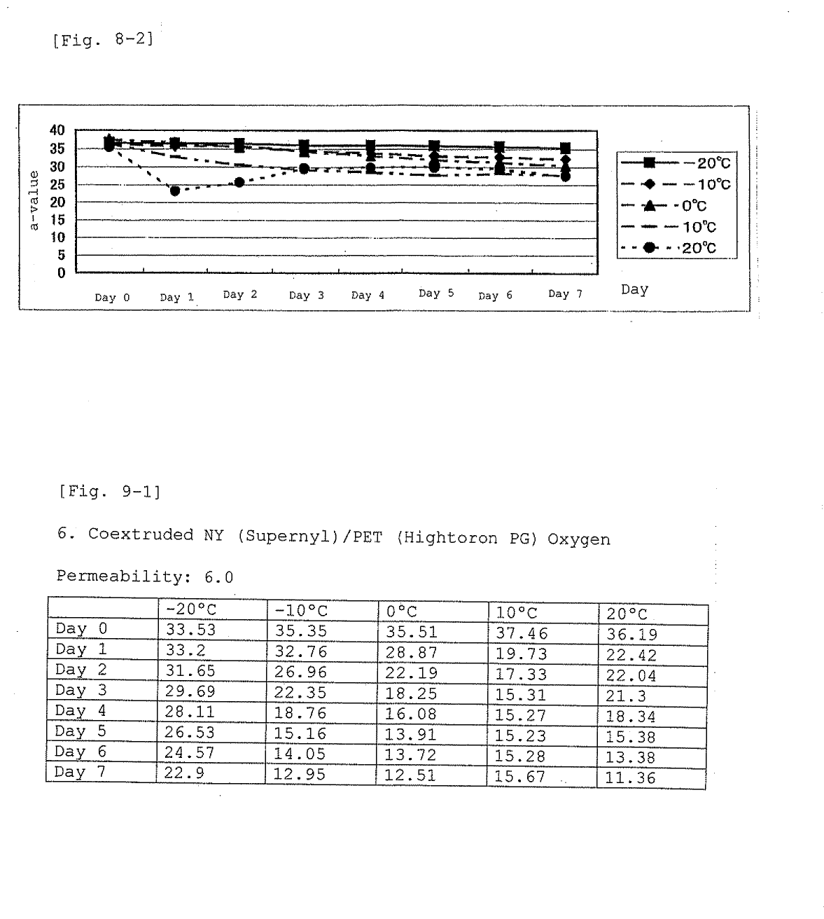

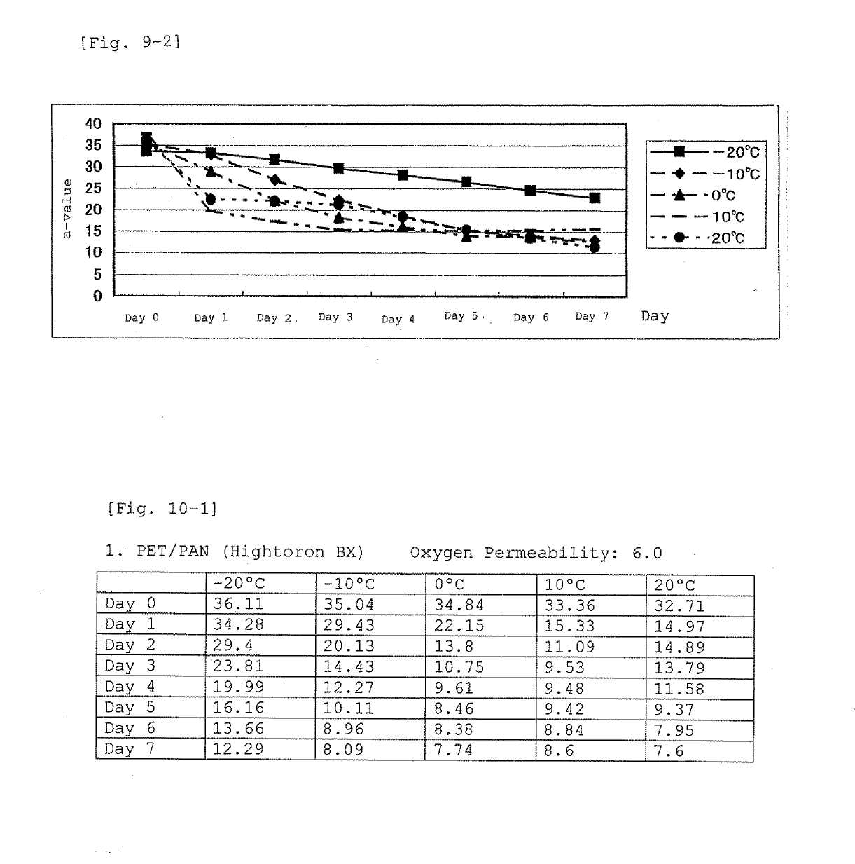

The results are shown in FIG. 2-1 to FIG. 10-2, respectively, similarly to preparation example 1.

1. A temperature history indicator comprising:
an oxygen detecting agent main body which is changed in color in response to the oxygen concentration; and
a slightly gas-permeable packaging film for sealing and coating the oxygen detecting agent main body.

2. The temperature history indicator according to claim 1, wherein the packaging film has an oxygen permeability at 25° C. of 0.1 to 50 ml/m².day, as measured by an oxygen permeation instruments (OX-TRAN2/21 Series MD Type; manufactured by Mocon Corp.).

3. A temperature history indicator according to claim 1, wherein the packaging film is a laminated film produced by laminating two or more films each consisting of any one polymer selected from polyethylene terephthalate (PET), polyacrylonitrile (PAN), polyamide (NY) and polyethylene (PE) and each of the laminated films or a film for each layer constituting each laminated film may be biaxially stretched.

4. The temperature history indicator according to claim 1, wherein the oxygen detecting agent main body is a carrier having a solution supported thereon, wherein the solution contains a reductive saccharide, an alkali metal compound and a dye which is reduced by a reductive saccharide to be identifiably changed in color.

5. The temperature history indicator according to claim 4, further comprising a dye which is not reduced by the reductive saccharide.

6. A temperature history indicator set comprising:
the temperature history indicator according to claim 1; and
a color sample showing a relationship between a temperature and a change in color tone with time.

7. A method of controlling a temperature history of goods by utilizing the temperature history indicator according to claim 1 which is identifiably changed in color in response to the oxygen concentration in the temperature range of at least −10° C. to +10° C.

8. A method of controlling a temperature history of goods by utilizing the temperature history indicator of claim 1 including providing a color sample showing a relationship between a temperature and a change in color tone with time.
